(19) United States
(12) Patent Application Publication
(10) Pub. No.: US 2003/0170094 A1
(43) Pub. Date: Sep. 11, 2003

(54) Method for binding books and a cutter therefor

(76) Inventor: Lai Chean Yew, Selangor (MY)

Correspondence Address: WEINGARTEN, SCHURGIN, GAGNEBIN & LEBOVICI LLP, TEN POST OFFICE SQUARE, BOSTON, MA, 02109, US

(21) Appl. No.: 10/365,775

(22) Filed: Feb. 13, 2003

(30) Foreign Application Priority Data
Mar. 9, 2002 (MY) PI 2002 0853

(51) Int. Cl. B42B 5/08

(52) U.S. Cl. 412/7

(57) ABSTRACT

There is disclosed a new method for binding a book and a new cutter therefore. The method comprises perforating a plurality of signatures along a spine, bending the plurality of signatures along the spine, compiling the plurality of signatures into a book text and applying adhesive to the book text. A cutter for making perforation adapted for the method is also disclosed.

### 1.0 TECHNICAL FIELD OF THE INVENTION

The present invention relates generally to a method for binding books, especially to a method for making alternate flaps along spine of a multi-layered signature, and a new perforating cutter therefor. These alternating flaps form the basis of a new method in the binding process, called the “LOCK SYSTEM”.

### 2.0 BACKGROUND OF THE INVENTION

It is known that books bound by the conventional perfect binding have extreme difficulties in withstanding rough handling. Books that use heavily coated papers are most likely to break apart with repeated handling. These problems have been overcome by the relatively more expensive thread sewing in the spine.

The problem of the perfect binding lies in the preparatory steps on the signature spine. Conventionally, a collection of multi-layered signatures that forms a book, bound for perfect binding using hot-melt adhesive, passes through a milling station in the perfect binding machine. The milling station, consisting of knives, slashed the spine laterally to expose interleaved sheets of the signatures. The exposed interleaved spine then passes through a glue station where hot melt adhesive is applied. The area exposed to the adhesive is limited to the length of the spine and the thickness of the book. If excessive adhesive is applied, the adhesive will seep through the multi-layered sheets, allowing for additional gluing areas.

In another recent technique for perfect binding, the spine of the multi-layered signatures is punched with spaced holes. When the fold is made along the spine, each hole creates a fan-shaped opening called notch. When the book passes through the hot melt station, the adhesive seep into the openings, filling the notches, thereby creating a knot. Using this method, the intermediate leaves are lock-in by the knot, bonding between the middle layer and outer layer. However, the middle pages are still fragile when subjected to abuses. Further, care has to be taken when applying adhesive as insufficient application will result in the adhesive not reaching the middle pages.

Therefore, there arises a need to provide a new method of binding which will result in a strong enough binding that allow the book to be opened flat or even backwardly without adversely affecting the book. There also arises a need to provide a novel cutter that can perforate signatures in a manner that results in a stronger perfect binding.

### 3.0 SUMMARY OF THE INVENTION

It is the object of the present invention to provide a method binding a book capable of withstanding heavier abuses. In using this method, there will not be any increase in the production cost nor time.

It is another object of the present invention to provide a cutter capable of perforating signatures that result in better bonding of the signatures.

These and other object of the present invention are accomplished by,

A method for binding a book having a plurality of signatures, comprising;

perforating said plurality of signatures along a spine;

bending said plurality of signatures along said spine;

compiling said plurality of signatures into a book text; and

applying adhesive to said book text,

characterised by

said perforating being to produce flaps along said spine.

And,

In a process for binding a book having a plurality of signatures, a cutter for perforating said signatures is provided, said cutter comprising;

a plurality of spaced knives on both sides of said cutter; and

each of said plurality of spaced knives has a spaced gap separating one from another,

characterised by

each of said plurality of spaced knives is positioned on alternating sides of said cutter and has a one-sided base cutting edge sharpened out from one side of said cutter to the other side.

The preparatory step to the present invention begins at the last fold in the folding machine or in the folding unit of a web printing press, whereby a new perforating cutter is installed. This cutter will perforate on one side of the signature spine and breaks the perforation across the spine. The subsequent perforation will be made on the other side of the spine and similarly breaking the perforation across the spine. Each perforation is separated by a gap called tie. The perforation pattern follows in an alternate sequence. When the signature is folded along the spine, each perforation will protrude out from the spine as flap on one side of the signature and an accompanying notch in the other.

When a series of signatures are gathered to form a book and passed through a hot melt station, the adhesive will coat the flaps. These flaps will then plant themselves permanently into the layer of adhesive between the block of signatures and the cover. The adhesive on the alternate flaps lock in the multi-layered sheets evenly.

Since the flaps are along the spine, they act as hinges for each pages, allowing the books to be opened in a flat manner or folded backwards with minimum lever pressure on the spine when the pages are pressed along the spine.

Simultaneously, knots will form in the notches left by the flaps, providing additional binding strength in forming the book.

### 4.0 BRIEF DESCRIPTION OF THE DRAWINGS

FIG. 1 is a complete perfect binding process using the conventional method starting from the last perforation of the signature to the gluing of covers.

FIG. 2A, 2B and 2C is a perspective view of the cutter according to one embodiment of the present invention.

FIG. 3A, 3B and 3C is a perspective view showing the perforation using the invention of FIG. 2.

FIG. 4 is a perspective view showing a sample view of a folded signature using the preferred perforation.

FIG. 5A and 5B is a simplified view of the application of adhesive when a block of signatures passes through the hot melt station and the seven strategic areas where the adhesive will be applied.

FIG. 6 is a comparative view of the bonding of the spine between the two current practices and the preferred design, called the “LOCK SYSTEM”.

### 5.0 DETAILED DESCRIPTION OF THE INVENTION

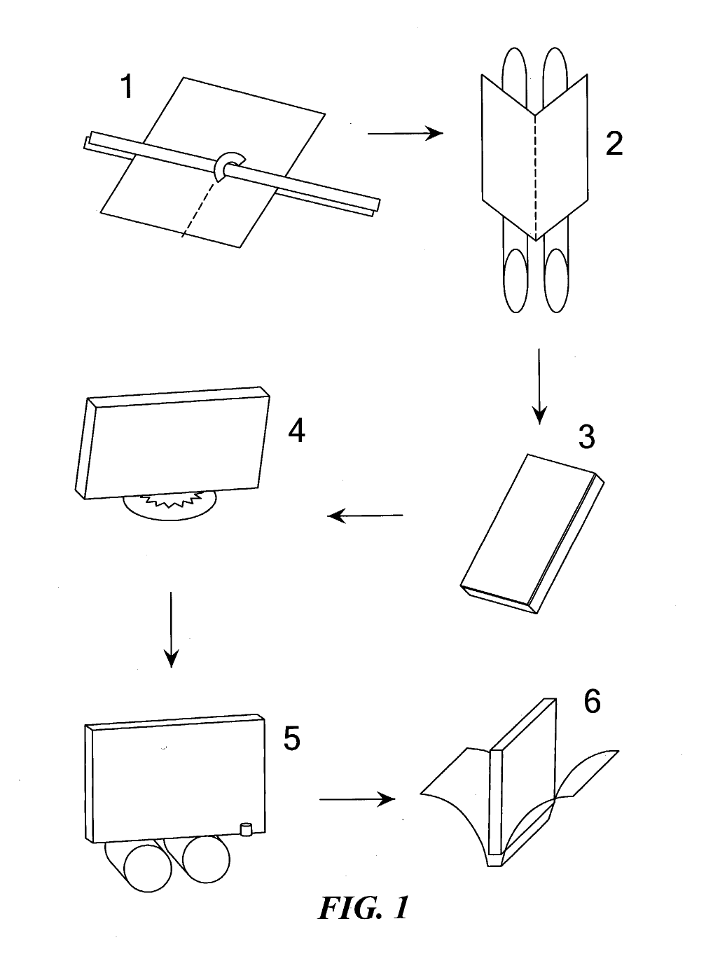

FIG. 1 shows the different steps in the perfect binding system. Whether in the Web printing process or the sheet printing system, the large printed sheets will need to be folded to the final book size before the actual binding process. In the conventional system, any signature that is designed to be perfect bound is ideally perforated at the spine as shown in 1, solely to reduce creases or wrinkles forming on the inside page of the multi-layered folded signature. Once the signature is perforated, it will pass to the folding section to be folded as shown in 2. In forming the book text in 3, several different folded signatures are compiled together. This book text is now in the perfect binding process.

In the perfect binding machine, the book text, as shown in 4, is passed through a milling station where the spine of the book text is milled laterally into a rough flat base. After the milling process, the book text will, in the same machine, passed through the hot melt station. In the hot melt station, the adhesive is melted using high heating elements in a basin. In the basin, there are usually two large diameter rollers that are soak into the adhesive. The low viscosity melted adhesive will coat onto the rollers as these rollers rotate. When the book text passes on top of the rotating adhesive coated rollers, as shown in 5, the book spine is adjusted to passes through the adhesive. After the adhesive is applied, the book is then case into a cover forming a complete book, as shown in 6.

In the entire binding process, the present invention differs in the perforating design, giving rise to a new perforating cutter and a new binding system. The resulting perforation is then used in the binding process without passing through the milling station.

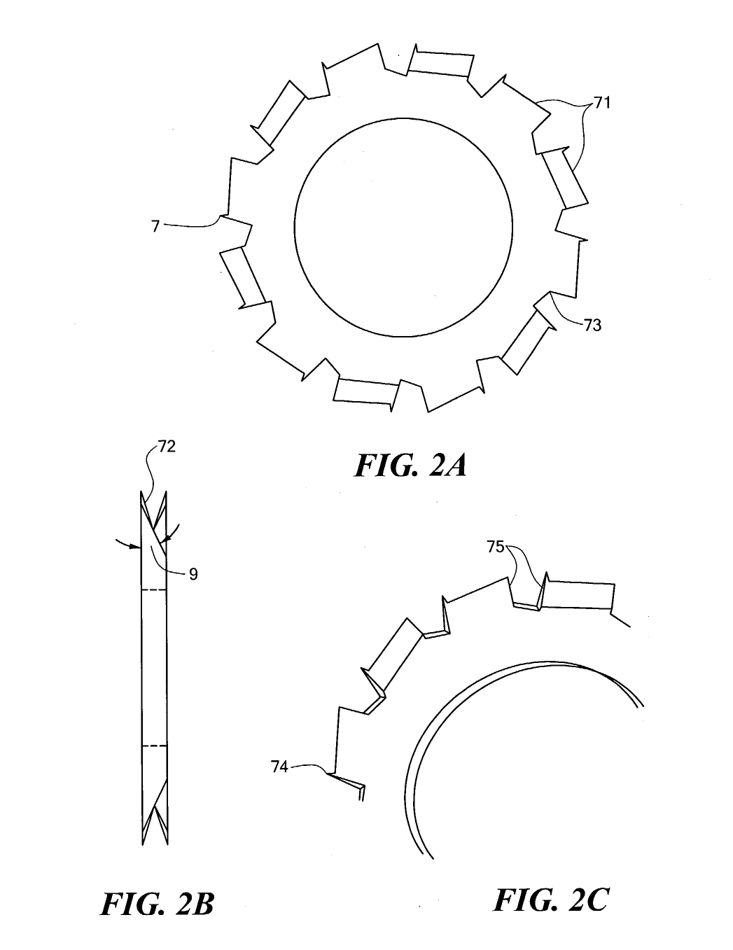

Referring to FIG. 2A, 2B and 2C the apparatus is a rotary perforating cutter (7) for the sole purpose of making flaps along the spine of a multi-layered signature designed to be bound by the perfect binding process. It is mounted in the last scoring section of the folding unit before the final folding rollers in the folding machine or the folding unit of a web printing press. The rotary perforating cutter (7) is to perforate along the sides of the signature spine, prior to the final folding of a signature.

The rotary perforating cutter (7) has a plurality of spaced knives (71) on both sides of the blade. Each of these knives (71) is positioned on the alternating sides of the cutter (7) and has a one-sided base cutting edge (72), sharpened out from one side of the cutter to the other side. Each of these knives (71) has a spaced gap (73) separating from one another.

At the end of the each knife, the cutting edge protrudes out into a needle (74). The protruding needle (74) at the end of each knife is for the purpose of breaking the perforation from the back to the front before the front perforation reaches completion. In so doing, it allows the necessary time for the rear perforation to break laterally across the spine. In cases of heavier texture papers, the knife without the protruding needle will similarly break the perforation across the spine without difficulties but may post some difficulties for lighter weighted or soft textured papers.

For each of this base cutting edge (72), the angle (a) of the sharpening varies from 20 degrees to 30 degrees (claim 3). If the angle (a) of the sharpening is too narrow, it will reduce the thickness of the knives. As a result, the perforation will not break across the spine. If it is too large, the perforation will not cut through the signature and if it does, it may result in a punch-perforation cutting.

The front and rear edge of each knife has a blunt cutting edge (75). These blunt edges (75) assist the breaking of the perforation across the spine and together with the thickness of the knives forced the perforation to break across the spine.

The measurement of the cutter (7) is such that the length of each knife is approximately 11 mm. The height of the knife at the tip is approximately 10 mm from the bore, with the sharpened edge of the knife slanting downwards to the back by 1 mm at the base of the rear needle. The height of the protruding needle (74) is approximately 10 mm from the bore. The gap (73) between each knife is approximately 8 mm at the tip. The cutter (7) has a thickness of 1 mm to 1.5 mm, depending on the thickness of the signature. However, these measurements are variable in accordance to the required size of the cutter.

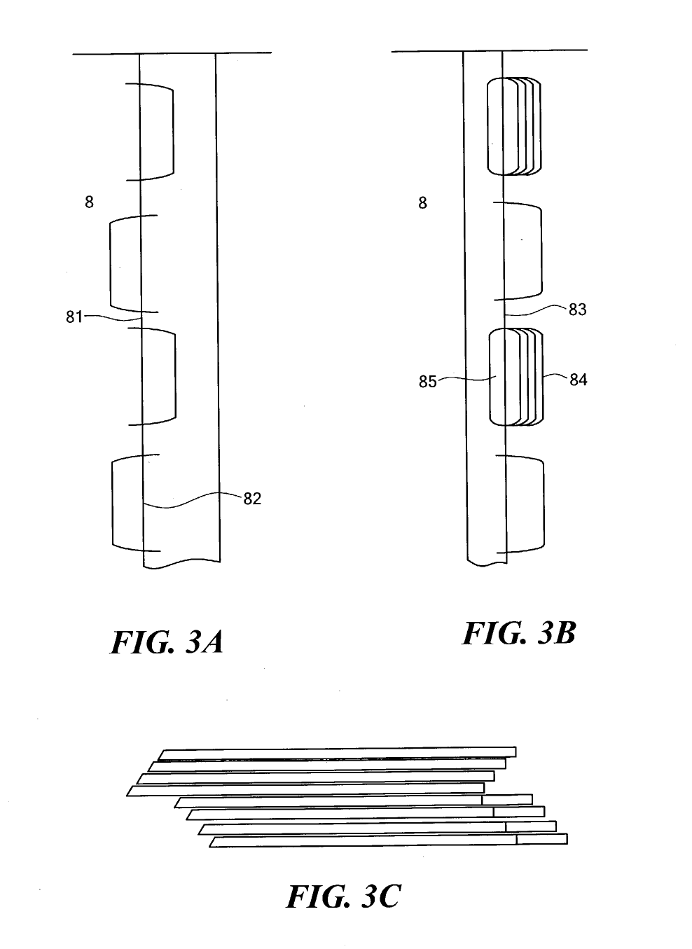

FIG. 3A, 3B and 3C shows a perforated foldable signature (8) using cutter of the present invention. The knife will perforate on one side of the spine (81). The perforation (82) through the thickness of the knife, will break and cut laterally across the spine (81), where the spine (81) or the line of fold being the center of reference.

As the signature (8) moves forward, the gap between each knife results in an uncut section of the paper, called tie (83). It is important that the width of these ties (83) be shorter than the perforation (82) cut. Tie width is critical to the twisting action and tensile strength of the ties (83). It will affect the extent of the book opening after it is bound. Further, these ties (83) act as lock to the outer pages when the signature is bound.

After the tie (83), the following knife will perforate the other side of the spine and subsequently breaks and cuts laterally across the spine. The thickness of the cutter determines the width of the lateral cut. FIG. 3A shows the resulting perforation along the spine using perforating cutter of the present invention.

FIG. 3B shows the result of the perforations protruding out as flaps (84) when the signature is folded. It must be noted that the lateral cuts must break across the spine into the other side of the signature in order to form these flaps (84). These flaps (84) are not folded together with the spine because the breath of the flaps is below the minimum folding size of the folding machine when the final fold is made.

A cross-section of the flap in FIG. 3B shows the detail exposure of each layer of the signature (8). The breaking into flap leaves an adjacent notch (85) in the spine, exposing each layer inside the multi-layered signature.

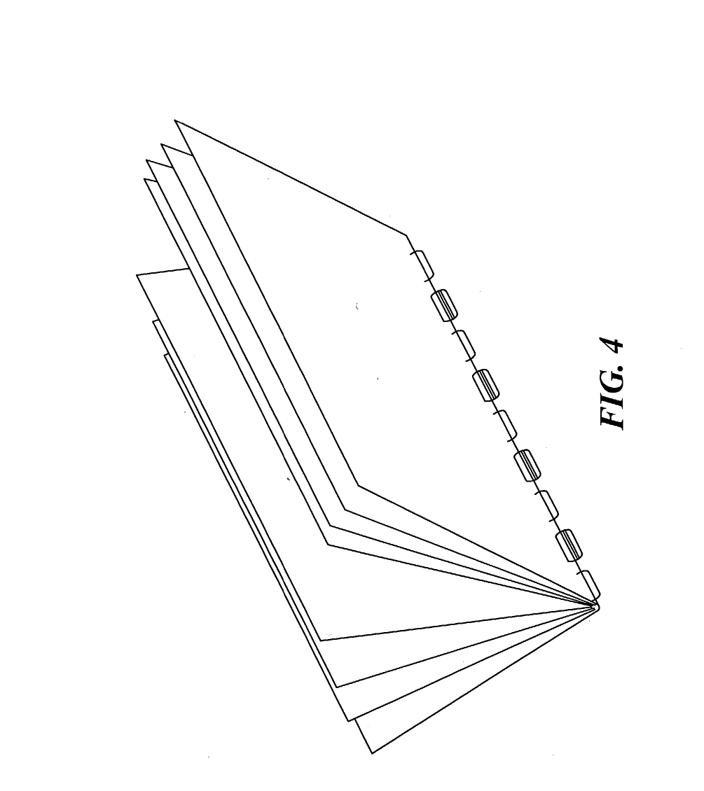

FIG. 4 is a perspective view showing a sample view of a folded signature using the preferred perforation.

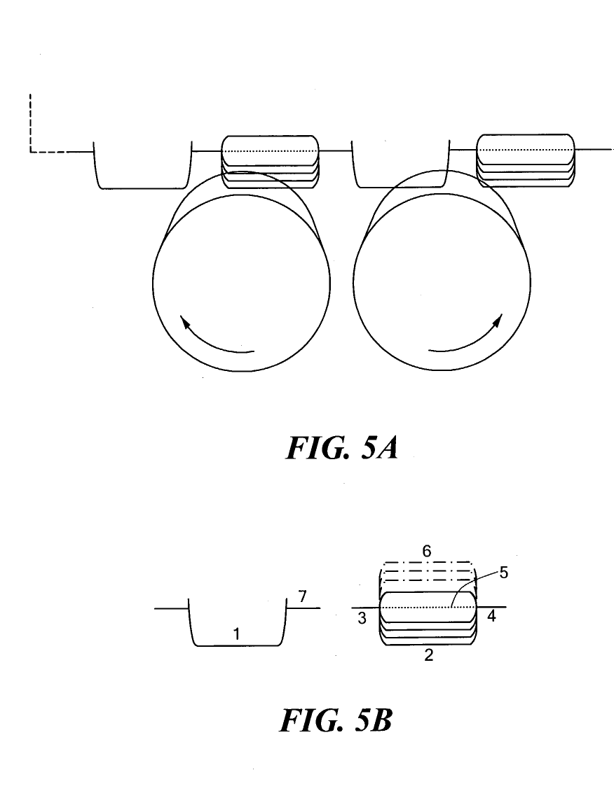

FIG. 5A and 5B show that when a collection of signature passes through the hot melt station, the flaps will soak into the adhesive on the hot melt application rollers, fully coating the flaps. As the flaps pass through the on-coming adhesive, the flaps will push the adhesive into the adjacent notches. When the adhesive is set, the alternating flaps will be planted into the adhesive between the signature block and the cover, thereby holding the signature evenly. The excess adhesive that seeps into the notches of the spine forming knots similar to the punch-perforating method.

The application of adhesive for this perfect binding design is the strongest and has a large surface area exposed to the adhesive. In this application, there are a total of seven areas exposed to the adhesive, as indicated in FIG. 5B. They are namely the two sides of the flaps (2, 6), the front and rear end of the flaps (3, 4), the adjacent notches (1), the outer side of the notches (5) and the uncut spine (7) or ties.

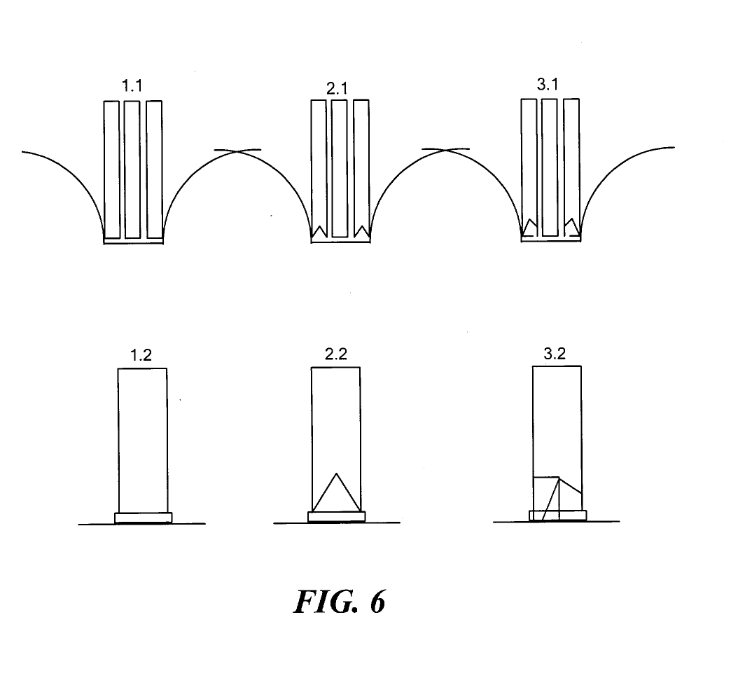

FIG. 6 is a comparative view of the bonding of the spine between the two current practices and the preferred design. Compared to the method in Diagram 1.1 and 2.1 that involves merely holding the pages or signature to the cover, the method on Diagram 3.1 extent a step further. It involves holding part of the signature in the form of flaps inside the layer of adhesive, thereby locking the signature permanently together. It is this design of permanent planting that renders this perfect binding method being able to withstand rough handling.

The usage of adhesive in this perfect binding design applies to hot-melt, cold adhesive and PUR. The preference of adhesive usage does not reduce the strength of the binding but it will affect the handling quality of the books.

Although the flaps alternate in position in each signature, their positions along the spine are not defined for different signature. As a result, the flaps being buried by a multi-signature book are at random position along the book spine. This random positioning is crucial because it eliminates weakness spots along the spine, which directly enhances the binding strength.

The flaps in the spine have two critical functions. First, the embedded flaps in the spine locked in the all the pages together, holding every page in the signature permanently. Hence, the book is able to withstand rough handling without loosening the pages. Second, the flaps are relatively more flexible because of the lower lever pressure at the spine. This flexibility allows these flaps to act as hinges to the pages on the book spine when the book is open.

With the combination of the two critical factors, books bound by the “LOCK SYSTEM” will ideally not only able to open in a flat manner, but also folded backwards without difficulties.

With the use of the present binding system, the milling station of the perfect binding machine is rendered useless. Nevertheless, we still retain the option to use the conventional perfect binding system if so chosen, as the flaps and notches will not affect the milling quality of the spine.

Since the present binding system depends solely on the perforating blade, the preferred perforating blade can be modified to size to fit into the folding unit of a web printing press.

What is claimed is:

1. A method for binding a book having a plurality of signatures, comprising;
perforating said plurality of signatures along a spine;
bending said said plurality of signatures along said spine;
compiling said plurality of signatures into a book text; and
applying adhesive to said book text,
characterised by
said perforating being to produce flaps along said spine.

2. A method for binding a book as claimed in claim 1, further characterised by when folded along said spine said flaps will be displaced in two rows in an alternating position.

3. A method for binding a book as claimed in claim 1, further characterised by said flaps will plant themselves permanently into a layer of said adhesive between block of said signatures and a cover.

4. In a process for binding a book having a plurality of signatures, a cutter (7) for perforating said signatures is provided, said cutter (7) comprising;
a plurality of spaced knives (71) on both sides of said cutter (7); and
each of said plurality of spaced knives (71) has a spaced gap (73) separating one from another,
characterised by
each of said plurality of spaced knives (71) is positioned on alternating sides of said cutter (7) and has a one-sided base cutting edge (72) sharpened out from one side of said cutter (7) to the other side.

5. A cutter as claimed in claim 3 further characterised by each of said plurality of spaced knives (71) being provided with a pointed needle (74).

6. A cutter as claimed in claim 3 further characterised by each of said plurality of spaced knives (71) being inclined at an angle (a) to said one sided base cutting edge (72).

7. A cutter as claimed in claim 3 further characterised by said angle (a) is about 20 degrees to 30 degrees.

8. A cutter as claimed in claim 3 further characterised by each of said knife (71) having a blunt front and rear (75) to assist in breaking the perforation.

9. A method for binding a book having a plurality of signatures, comprising;
perforating said plurality of signatures along a spine;
bending said said plurality of signatures along said spine;
compiling said plurality of signatures into a book text; and
applying adhesive to said book text,
characterised by
during said applying adhesive to said book text, there are seven glue position, namely the two sides of the flaps, front and rear of the flaps, the notch, the outer side of the notch and the outer ties.

10. A method for binding a book as claimed in claim 9 further characterised by said adhesive being hot melt adhesive, cold adhesive and PUR.
